(19) United States
(12) Patent Application Publication
(10) Pub. No.: US 2025/0384451 A1
(43) Pub. Date: Dec. 18, 2025

(54) Blockchain-Based Mineral Supply Chain Tracking and Authentication System

(71) Applicant: High Table LLC

(72) Inventors: John Martin Leufray, West Palm Beach, FL (US); Chad Michael Altieri, West Palm Beach, FL (US)

(21) Appl. No.: 18/744,817

(22) Filed: Jun. 17, 2024

(51) Int. Cl. G06Q 30/018; G06Q 20/40

(52) U.S. Cl. CPC G06Q 30/0185; G06Q 20/40

(57) ABSTRACT

This invention presents an advanced blockchain-based system for the precise tracking and authentication of supply chains for precious metals, base metals, and other minerals. Leveraging a blockchain network, it forms an immutable ledger that records all transactional data from extraction to final sale. Users engage with an intuitive interface for detailed entry of metadata, timestamps, and cryptographic signatures, with each entry undergoing verification using consensus algorithms before secure addition to the blockchain. The aggregation of multiple transactions forms a block, ensuring a transparent, traceable, and tamper-proof record of the entire supply chain, verifying mineral origins and provenance. The system empowers artisanal miners by providing direct access to international markets, enhancing their economic opportunities, and enables consumers to understand product origins, promoting ethical purchasing. Its architecture enhances supply chain security, tracking accuracy, and ethical standards, particularly in the jewelry and electronics markets, significantly reducing fraud and improving sustainability.

### RELATED FILINGS

In developing this invention, several pertinent U.S. patent documents were identified and thoroughly reviewed to ensure originality and highlight the unique contributions of the present system. Specifically:

U.S. Pat. No. 11,037,211-B2 (June 2021, Preston et al.): This patent explores methodologies and systems related to blockchain protocols, with a particular emphasis on authentication mechanisms within supply chains. While providing foundational insights, the present invention introduces significant advancements in granularity and verification procedures, distinguishing it from the prior work.

U.S. Pat. No. 10,664,797-B2 (May 2020, Chappell et al.): This document discusses cryptographic procedures employed within blockchain frameworks for supply chain management. Although it outlines essential cryptographic techniques, the current invention refines and optimizes these methods specifically for mineral tracking and supply chain fidelity.

U.S. Pat. No. 4,309,569-A (January 1982, Merkle): This seminal work on cryptographic hashing lays the groundwork for secure data structures and modern blockchain algorithms. Merkle's contributions provided the conceptual framework for the present system, which incorporates significant enhancements and application-specific modifications.

US-2018/0276600-A1 (September 2018, Fuller et al.): This application discusses blockchain-based management of supply chain integrity through material spectral signature validation. While it provides a foundation for blockchain use in the authentication of real-world assets, the present invention uniquely mandates comprehensive transaction data uploads to the blockchain at each transfer, ensuring traceability integrity and preventing unauthorized handling throughout the mineral supply chain.

US-2022/0222681-A1 (July 2022, Anastas): This application describes a blockchain-based system for verifying the chain of custody and provenance of precious metals like gold bars, using unique Bitcoin addresses and private key transfers for each sale. However, this system has limitations in complexity and ease of use. The present invention is unique as it requires users to complete a simple form to add data to the blockchain, needing no blockchain or coding knowledge. This eases the process for supply chain actors, enhancing traceability and preventing unauthorized handling.

In summary, while the aforementioned patents inform and contextualize aspects of the present invention, the unique methodological and architectural innovations introduced herein stand distinct, representing marked advancements in blockchain-based mineral supply chain tracking and authentication systems.

### TECHNICAL FIELD

The present invention introduces a system and methodological approach for the meticulous tracking and authentication of precious and base metals and other minerals from extraction to the end consumer. As outlined by 35 U.S.C. § 112, the invention is expounded upon in the ensuing sections. This invention is predominantly anchored on a blockchain-based architecture specifically tailored for transparent and verifiable record-keeping of transactional data related to precious and base metals and other minerals throughout the supply chain.

The system encompasses a systematic methodology and infrastructural setup adept at capturing, securing, and chronicling data linked to the extraction, processing, conveyance, and commercialization of said minerals within a cryptographic and consensus-driven blockchain database. This ensures the database's immutability, transparency, and fortified security. By employing such a mechanism, the system effectively ensures that the procurement and production of these minerals adhere stringently to ethical and sustainable benchmarks.

Additionally, this invention provides artisanal miners with more direct access to international markets, bypassing traditional intermediaries and enhancing their economic opportunities. Consumers, on the other hand, gain a clearer understanding of the origin of their end products, promoting informed purchasing decisions and ethical consumption. The system's applicability extends to the jewelry and electronics markets most directly, ensuring the traceability and credibility of minerals used in these industries.

Architecturally designed to cater to a wide range of stakeholders within the mineralogical ecosystem, the system includes miners, traders, exporters, importers, distributors, refiners, and jewelry and electronics manufacturers. It also proves indispensable for regulatory bodies, audit agencies, consumers, and third-party validation entities.

In essence, the present invention not only enhances the security and traceability of mineral supply chains but also promotes ethical mining practices, sustainable development, and transparency in the jewelry and electronics markets, providing a robust solution for the myriad challenges faced in the mineral industry.

### BACKGROUND

The present invention addresses the need for a system to trace minerals from their source through the entire value chain by requiring transaction data to be uploaded to the blockchain at each point of transfer. Unlike diamonds, which can be uniquely identified by their shape through scanning, gold ore and other base metals can be melted, thus obscuring its origin. By approving users to access the system, it ensures that no unauthorized parties were in possession of the mineral, thus eliminating the possibility for smugglers to intercept and profit from the mineral at any point in the supply chain.

Disclosed herein is a system and method for tracking and verifying the supply chain of precious metals, base metals, and other minerals using blockchain technology. This embodiment is not intended to be limiting and may be combined or implemented with other technologies. The supply chain may involve any type of mineral, including but not limited to gold, silver, platinum, coltan, cobalt, lithium, tungsten, tin, tantalum, or combinations thereof. The method comprises recording, verifying, and displaying data such as mineral weight, purity, and location throughout the supply chain, among other traceability data points.

The method further involves utilizing a user interface that captures and validates user inputs. Registered and verified users may input information such as mineral type, origin, weight, purity, and other supply chain management and transaction details. Input data type may vary depending on the mineral and user type.

The global precious metals, base metals, and minerals trade is a complex network of actors, including producers, cooperatives, negotiators, traders, dealers, secured transporters, exporters, importers, refiners, end-buyers, jewelers, electronic goods makers, car manufacturers, battery makers, generalized manufacturers, NGOs, governments, regulators, auditors, authenticators, and other stakeholders that operate within a fragmented and often opaque supply chain. This complexity makes it difficult to trace the origin of precious metals, base metals, and other minerals, leading to concerns about unethical and unsustainable mining practices, as well as the financing of criminal activities, terrorism, and money laundering.

To address these issues, this invention provides an immutable and transparent ledger of precious metals, base metals, and other minerals supply chain transactions. The platform is designed to allow all stakeholders to easily track the movement of precious metals, base metals, and other minerals from the point of origin to the point of consumption in compliance with current and evolving international standards. By providing a trusted source of information on the origin and authenticity of precious metals, base metals, and other minerals, the platform aims to promote ethical and sustainable practices in the global minerals trade.

The global minerals market is a multi-billion dollar industry, but many challenges are associated with tracing the origins and authenticity of precious metals, base metals, and other minerals often mined in developing countries with weak regulatory frameworks, where exploitation and human rights abuses are common. Additionally, precious metals, base metals, and other minerals may be smuggled or illegally traded, making it difficult to ascertain if they have been ethically sourced. This has led to concerns about the environmental and social impacts of precious metals, base metals, and other minerals mining, prompting many companies, multinational organizations, international organizations, and governments to seek ways to improve transparency and traceability in their supply chains.

Blockchain technology has emerged as a promising solution to these challenges. By using a distributed ledger to record transactions and store data, blockchain can provide a transparent and immutable record of the entire supply chain, from mining to refining to manufacturing to sale. This helps ensure that precious metals, base metals, and other minerals are ethically sourced, reducing the risk of fraud, sanctions evasion, money laundering, terrorist financing, and counterfeiting. It also improves the sustainability of the industry and provides transparency to the end-buyer regarding the supply chain of the precious metals, base metals, and other minerals they purchase.

While blockchain systems for tracking mineral supply chains currently exist, they have some limitations. They may be complex and difficult to use, may not provide a complete picture of the supply chain, lack real-time data updates, have limited interoperability with other systems, and may not offer sufficient support for regulatory compliance. Additionally, existing systems often cannot verify minerals are ethically sourced and conflict-free. There is a need for a more user-friendly and comprehensive blockchain-based system for tracking the supply chain of precious metals, base metals, and other minerals. The present invention addresses this need by providing a blockchain-based platform that is accessible to all participants in the supply chain and that provides a complete, transparent, and reliable record of the entire lifecycle of precious metals, base metals, and other minerals.

### SUMMARY

The present invention provides a blockchain-based platform that addresses challenges in the mining industry by offering a complete, transparent, and reliable record of the entire lifecycle of precious metals and minerals. This platform is designed to be user-friendly and accessible to all participants in the supply chain, from producers to end-buyers.

Key features and advantages of the invention include forming an immutable ledger that records all transactional data from extraction to final sale, ensuring data integrity and security by leveraging blockchain technology. Intuitive interfaces for different stakeholders, such as miners, auditors, exporters, importers, manufacturers, and end-buyers, facilitate the input, verification, and viewing of transaction data. Transactions undergo verification using consensus algorithms before being securely added to the blockchain, ensuring the authenticity and accuracy of the data. The system provides real-time updates, enhancing the ability to track and trace minerals throughout the supply chain.

By offering a transparent record, the system ensures that minerals are ethically and sustainably sourced, promoting responsible mining practices. Cryptographic links between blockchain nodes ensure the security and integrity of data, preventing unauthorized access and tampering. A public interface allows end-buyers and stakeholders to access a curated view of select, non-confidential transaction data, fostering trust and transparency.

This invention is particularly beneficial for the jewelry and electronics markets, where traceability and authenticity of minerals are critical. It provides artisanal miners with direct access to international markets, bypassing traditional intermediaries and enhancing their economic opportunities. Consumers gain a clearer understanding of the origins of their end products such as jewelry pieces and electronic devices, promoting informed purchasing decisions and ethical consumption.

By offering a robust solution to the myriad of challenges faced in the mineral industry, this invention not only enhances the security and traceability of mineral supply chains but also promotes ethical mining practices, sustainable development, and transparency, ultimately benefiting a wide range of stakeholders within the mineralogical ecosystem.

### BRIEF DESCRIPTION

A more complete understanding of the systems, methods, processes, and/or apparatuses disclosed herein may be derived by referring to the detailed description when considered in connection with the following illustrative figures. In the figures, like-reference numbers refer to like-elements or acts throughout the figures.

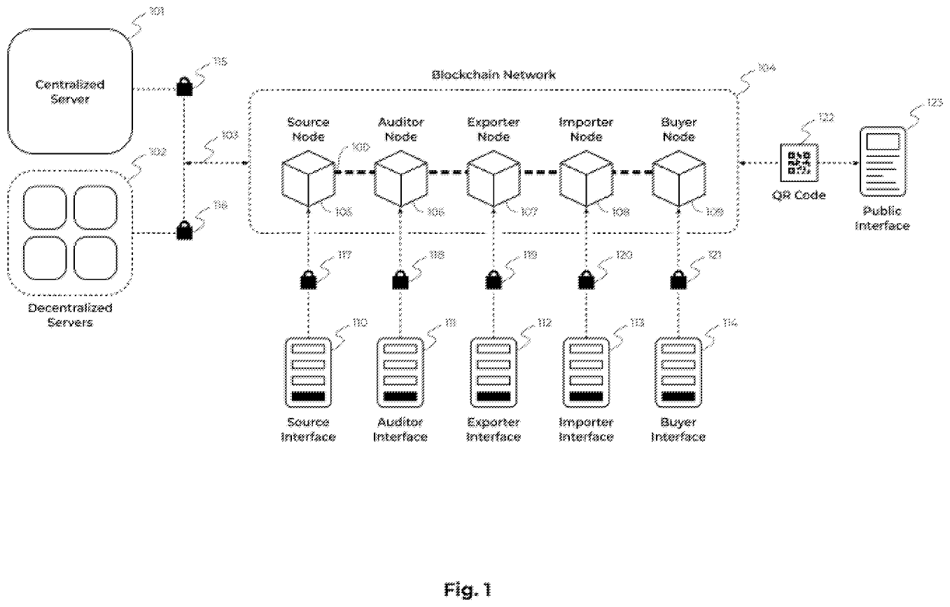

FIG. 1 depicts an embodiment of the System Architecture Diagram, illustrating the interactions between the central blockchain network, servers, and user interfaces.

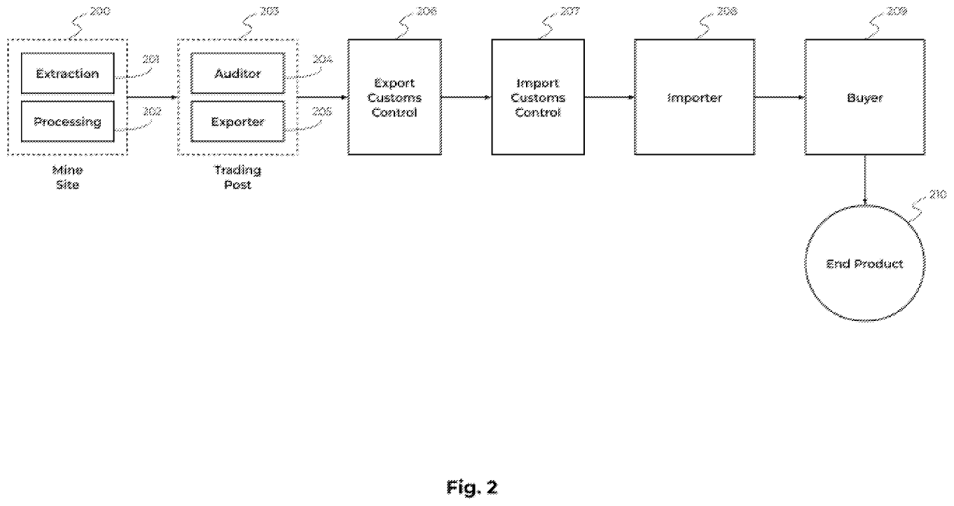

FIG. 2 depicts an embodiment of the Mineral Supply Chain, showcasing the sequence of mineral sourcing, validation, transportation, and purchase.

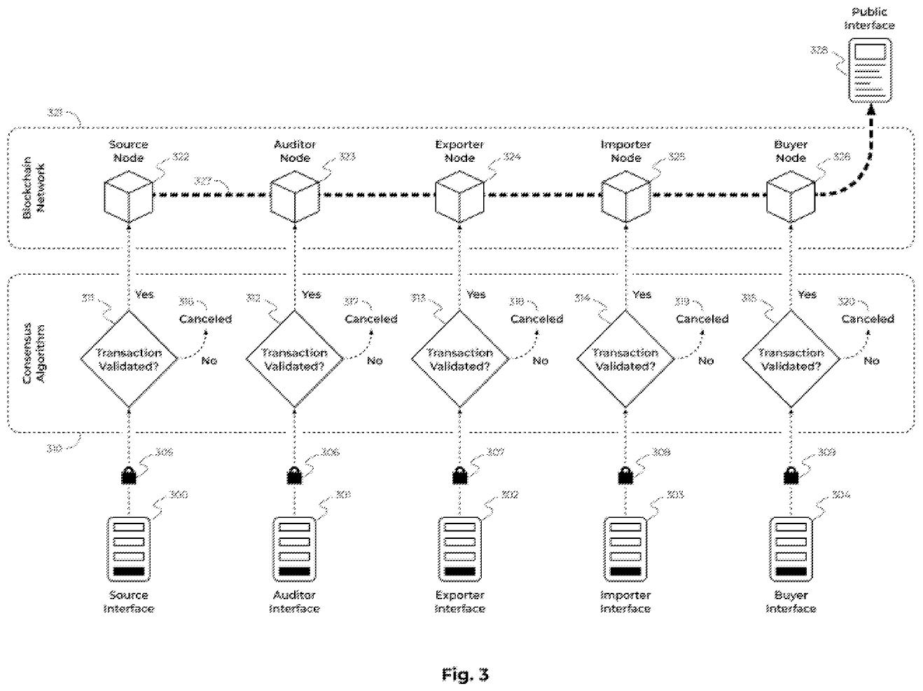

FIG. 3 depicts an embodiment of a Consortium Blockchain Mining Process as integral to this invention.

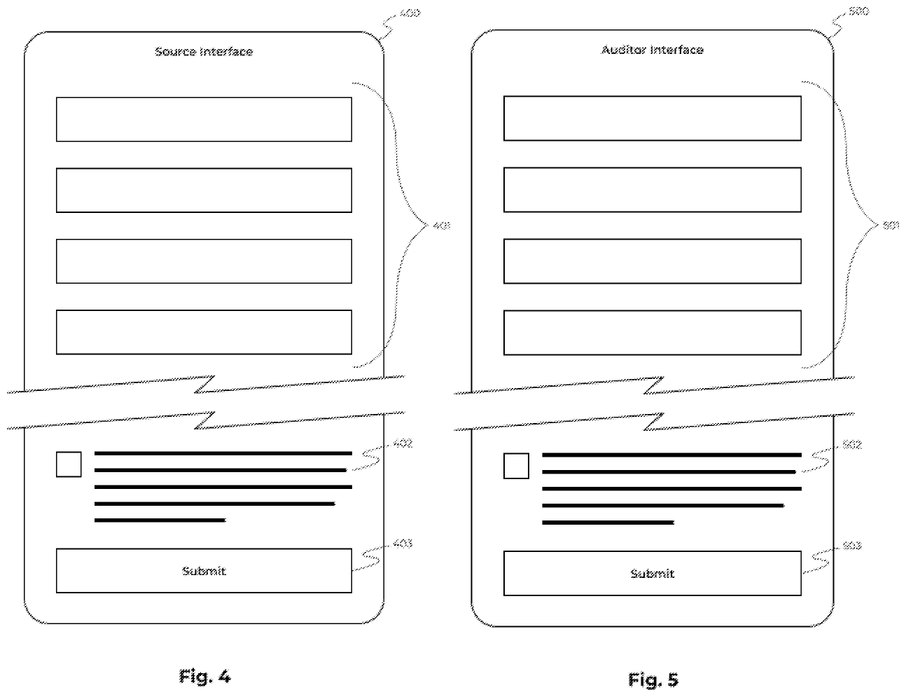

FIG. 4 depicts an embodiment of a Source Interface software window, designed for the mineral sourcing entity to accurately input transaction data.

FIG. 5 depicts an embodiment of an Auditor Interface software window, tailored for the mineral authentication agency, emphasizing data input mechanisms.

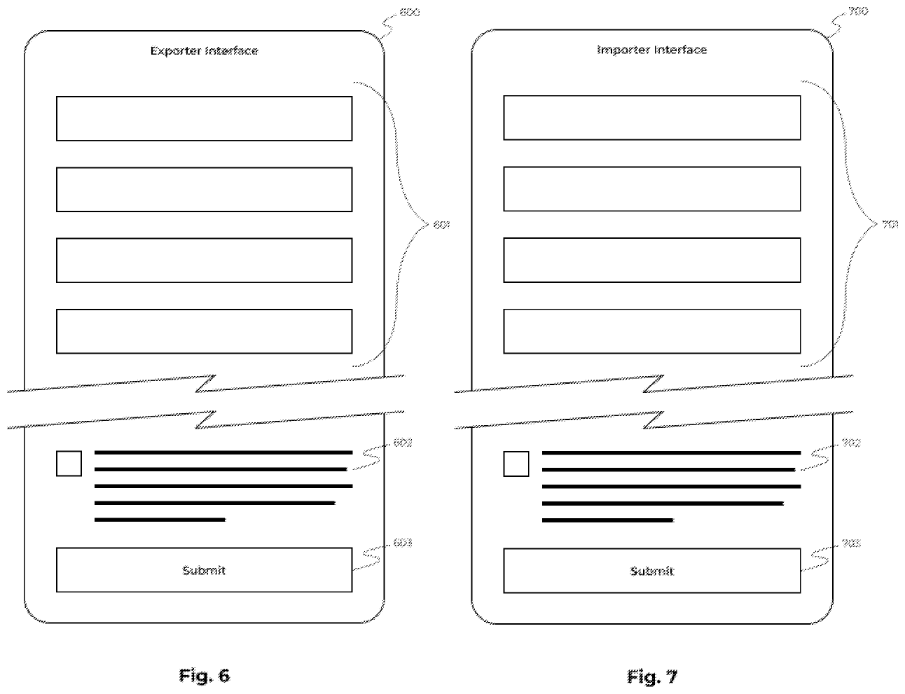

FIG. 6 depicts an embodiment of an Exporter Interface software window that facilitates the mineral exporter in entering relevant transaction data.

FIG. 7 depicts an embodiment of an Importer Interface software window, crafted for the mineral importer to ensure precise data entry.

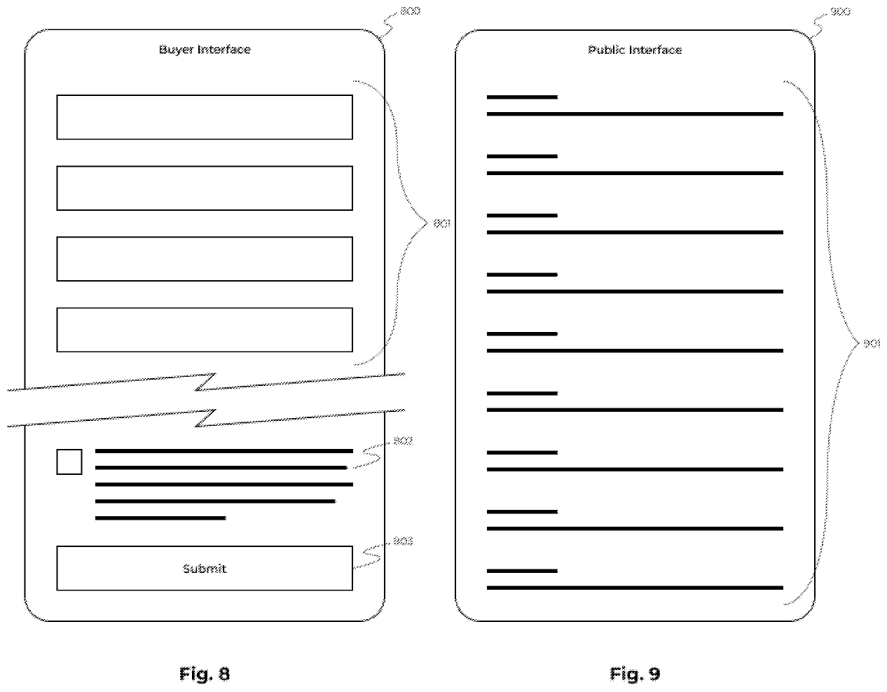

FIG. 8 depicts an embodiment of a Buyer Interface software window, structured for the mineral buyer or manufacturer to facilitate data input processes.

FIG. 9 depicts an embodiment of a Public Interface software window, enabling the mineral end-buyer or other pertinent stakeholders to verify and peruse limited transaction data.

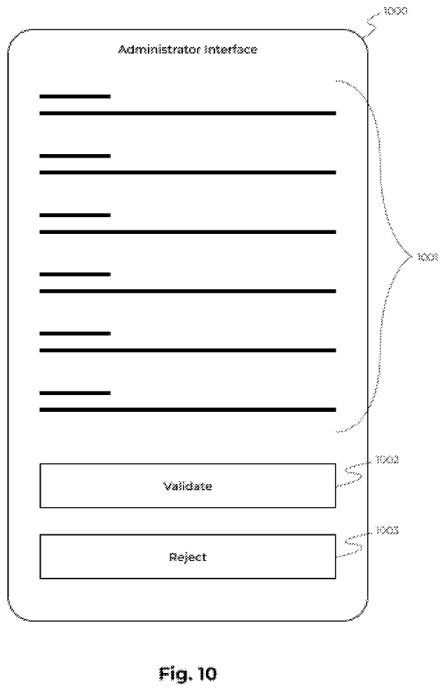

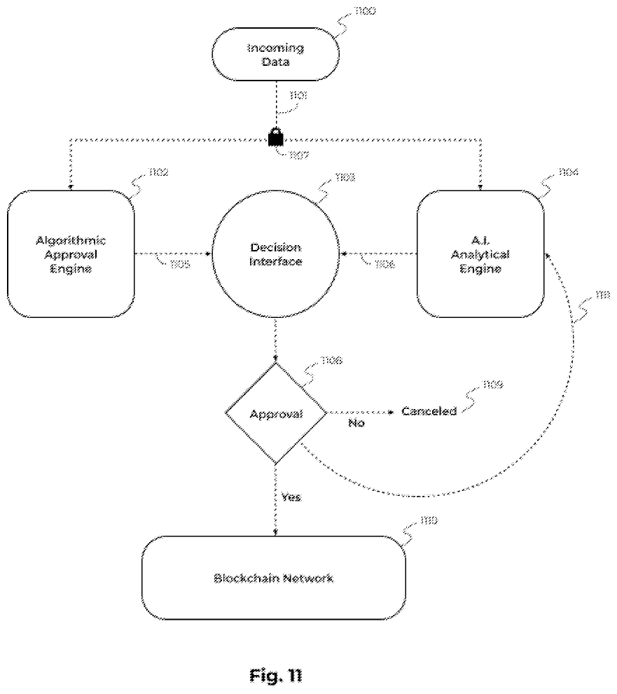

FIG. 10 depicts an embodiment of an Administrator Interface software window for the software developer to validate, verify, and integrate input data before it is added into the blockchain.

FIG. 11 depicts an embodiment of an Automatic Approval Module designed to automate and streamline the blockchain submission process.

Elements and acts in the figures are illustrated for simplicity and have not necessarily been rendered according to any particular sequence or embodiment.

### DETAILED DESCRIPTION

In the following description, and for purposes of explanation, numerous specific details, processes, and specific inputs are set forth to provide a thorough understanding of various aspects of exemplary embodiments. However, it will be understood by those skilled in the relevant arts that the apparatus, systems, and methods herein may be practiced without these specific details, processes, and inputs. It is to be understood that other embodiments may be utilized, and structural and functional changes may be made without departing from the scope of the apparatus, systems, and methods described herein. In other instances, known structures and devices are discussed more generally to avoid obscuring the embodiments. Often, a description of the apparatus is sufficient to enable one to implement the various forms, particularly when the system is to be implemented in software. It should be noted that many different and alternative configurations, devices, and technologies to which the disclosed embodiments may be applied exist. The full scope of the embodiments is not limited to the examples described below.

Further, the following examples include illustrated embodiments and references made to the accompanying drawings, which form a part hereof and are shown by way of illustration of various embodiments in which the systems, methods, processes, and apparatuses disclosed herein may be practiced. It is to be understood that other embodiments may be utilized, and structural and functional changes may be made without departing from the scope.

FIG. 1 is a System Architecture Diagram, showing the blockchain-based architecture tailored for the tracking of mineral supply chains. The system is anchored by a Blockchain Network 104, designed to capture, secure, and convey transactional data at specific checkpoints throughout the mineral's journey. The system can operate with more or fewer user types/nodes and still fall under this patent.

The Blockchain Network 104 comprises a series of interconnected nodes, each encapsulating a specific stage in the mineral supply chain. The connection between these nodes forms the Blockchain 100. To begin, the Source Node 105 documents the initial extraction phase of the mineral. This node captures critical data parameters, including but not limited to, the geological origin, exact date of extraction, and preliminary quality assessments conducted on the raw minerals. This preliminary data serves as a foundational layer for subsequent nodes.

Next, the Auditor Node 106 acts as a verification and assurance checkpoint. This node integrates exhaustive details from post-extraction audits, assimilates statutory compliance verifications, and encapsulates any certification information provided by external auditing entities. This ensures that every subsequent transaction concerning the mineral aligns with regulatory and ethical standards.

The Exporter Node 107 is engineered to chronicle an array of transactional details as the mineral proceeds to international transit. The data captured includes export permits, shipment logistics, consignee and consignor information, and delivery details.

Upon its international arrival, the Importer Node 108 is tailored to register details surrounding the mineral's ingress. Such details encompass import licenses, customs clearance documents, initial reception records, and any preliminary quality reassessments post-transit.

The final point is the Buyer Node 109, which documents the culmination of the mineral's journey; the final transaction. Detailed acquisition parameters, comprehensive buyer credentials, transaction timestamps, and any other relevant data are incorporated in this node.

External to the Blockchain Network's 104 core structure, the invention incorporates both Centralized Servers 101 and Decentralized Servers 102. While the centralized servers primarily function to orchestrate controlled data access, manage holistic storage solutions, and synchronize overarching tasks, the decentralized servers inherently enhance system security, strategically minimizing centralized vulnerability points. Furthermore, they are calibrated to handle distributed data validation tasks, ensuring data integrity across the network. Data is secured from the Centralized Servers 115 and the Decentralized Servers 116, which transmit encrypted data to and from the Blockchain Network through a Two-Way Connection 103.

Direct interactions between data sources in the supply chain and the Blockchain Network 104 are channeled through specialized user interfaces, each uniquely calibrated for each designated role within the consortium. These interfaces are crafted to facilitate seamless and secure data inputs corresponding to each respective stage. The Source Interface 110 transmits data securely via the Source Network 117. The Auditor Interface 111 transmits data securely via the Auditor Network 118. The Exporter Interface 112 transmits data securely via the Exporter Network 119. The Importer Interface 113 transmits data securely via the Importer Network 120. The Buyer Interface 114 transmits data securely via the Buyer Network 121.

Positioned to enhance transparency, Public Interface 123 accesses data from the Blockchain Network 104 using a QR Code 122 affixed to the end product. This feature empowers end-consumers, granting them the capability to access a curated compendium of data from the blockchain. In essence, it allows them to trace and validate the mineral's comprehensive supply chain provenance.

The invention's architecture is governed by stringent communication protocols. These protocols, as depicted, leverage encrypted channels for data transfer, ensuring the sanctity of data at every juncture. Augmenting this security paradigm are robust access control mechanisms, bolstered by state-of-the-art cryptographic security layers. These layers serve a dual purpose: they fortify data inputs, ensuring only authorized entities have access, and they safeguard transactional records, guaranteeing confidentiality and integrity.

In reference to FIG. 2, the described embodiment charts the journey of minerals from their origin to the final consumer within a structured Mineral Supply Chain. The system is flexible and can operate with more or fewer user types while still falling under this patent. The supply chain starts at the Mine Site 200, where the minerals are procured directly from their natural repositories. Mineral Extraction 201, using a combination of specialized machinery and methodologies, pulls out minerals in their raw state. Once extracted, these minerals undergo Processing 202 through a series of refining steps designed to upgrade their quality and properties for further stages in the supply chain.

Following this foundational phase, the minerals are transported to the Trading Post 203, where an Auditor 204, utilizing an array of diagnostic tools and protocols, inspects and validates the minerals' origin, quality, and legitimacy. This rigorous evaluation ensures that the minerals align with stipulated standards, paving the way for their subsequent certification. After this auditing procedure, the minerals transition into the custody of the Exporter 205. The Exporter prepares the minerals for their international journey, encompassing measures such as appropriate packaging, labeling, and the assembly of essential documentation.

Prior to shipping, the minerals are scrutinized by the Export Customs Control 206. This regulatory entity ensures that outbound minerals are in strict compliance with established trade conventions and safety protocols, examining their accompanying documentation and certifications meticulously. Upon reaching their destination, the minerals are received by the Import Customs Control 207, a counterpart to the export entity. Here, the minerals' adherence to the importing nation's stipulations, encompassing quality benchmarks and safety regulations, is vigorously assessed before being transferred to the custody of the Importer 208.

The concluding stages of the mineral's journey involve its acquisition by the Buyer 209. Once purchased, these minerals are integrated into sophisticated production processes, culminating in the creation of the End Product 210. This final product, enriched with the refined mineral, is then prepped for sale, marking its availability for acquisition by the end-consumer.

This flexible system architecture allows for the addition or removal of user types, adapting to different supply chain configurations while maintaining the integrity and traceability of the mineral journey from extraction to the end consumer.

FIG. 3 depicts the Consortium Blockchain Mining Process, wherein a blockchain is conceptualized as a network of interconnected sets of data inputs. The interconnectivity of these inputs serves a dual purpose: ensuring data integrity and validating and authenticating every transaction. The system can operate with more or fewer user types/nodes and still fall under this patent.

Central to the consortium's functional efficacy is the Consensus Algorithm 310, operating in tandem with each transaction entry. Transaction data from the source is entered in the Source Interface 300 and encrypted through a Secure Connection 305 before entering the consensus algorithm 310. Transaction data from the auditor is entered in the Auditor Interface 301 and encrypted through a Secure Connection 306 before entering the consensus algorithm 310. Transaction data from the exporter is entered in the Exporter Interface 302 and encrypted through a Secure Connection 307 before entering the consensus algorithm 310. Transaction data from the importer is entered in the Importer Interface 303 and encrypted through a Secure Connection 308 before entering the consensus algorithm 310. Transaction data from the buyer is entered in the Buyer Interface 304 and encrypted through a Secure Connection 309 before entering the consensus algorithm 310.

Within the consensus algorithm 310, transactions are submitted and held pending validation. Each transaction awaits its turn, and upon receiving approval from the consensus protocol, it transitions to the Blockchain Network 321. Source transaction data is submitted to the Source Validation Protocol 311; if it is verified, it is added to the blockchain; if it is not verified, it is canceled 316 and not added to the blockchain. Auditor transaction data is submitted to the Auditor Validation Protocol 312; if it is verified, it is added to the blockchain; if it is not verified, it is canceled 317 and not added to the blockchain. Exporter transaction data is submitted to the Exporter Validation Protocol 313; if it is verified, it is added to the blockchain; if it is not verified, it is canceled 318 and not added to the blockchain. Importer transaction data is submitted to the Importer Validation Protocol 314; if it is verified, it is added to the blockchain; if it is not verified, it is canceled 319 and not added to the blockchain. Buyer transaction data is submitted to the Buyer Validation Protocol 315; if it is verified, it is added to the blockchain; if it is not verified, it is canceled 320 and not added to the blockchain.

By this mechanism, the blockchain ensures that each transaction undergoes a rigorous vetting process across the network. Only upon mutual agreement and validation by the nodes, predicated on established protocols, is a transaction deemed valid and subsequently incorporated into the Blockchain 327. Validated source transaction data is submitted to the Source Node 322. Validated auditor transaction data is submitted to the Auditor Node 323. Validated export and exporter transaction data is submitted to the Exporter Node 324. Validated import and importer transaction data is submitted to the Importer Node 325. Validated purchase and buyer transaction data is submitted to the Buyer Node 326.

A distinct feature that sets the consortium model apart is the stratified access rights of the nodes. Some nodes have limited access parameters. This hierarchized access system ensures that not all participants in the blockchain have homogenous authority levels. By modulating access, the system achieves a balance between transparency and privacy, ultimately enhancing the blockchain's security parameters.

An additional layer of sophistication in the Consortium Blockchain Mining Process is the inclusion of the Public Interface 328. This interface, distinct from the private nodes of the consortium, allows external entities to access a curated selection of data from the blockchain. While the consortium retains control over the bulk of the data, the public interface is designed to foster transparency by offering selected data from the blockchain transactions. This interface signifies the blockchain's adaptability, striking a balance between exclusive access for consortium members and limited accessibility for external entities.

FIG. 4 depicts a Source Interface 400 tailored for the mineral sourcing entity, designed to collate comprehensive data about the mineral's provenance and characteristics. The Data Input Fields 401 capture the mineral's intrinsic properties, including categories such as mineral type, quality parameters, and source details.

The interface captures the mineral's attributes, encompassing broad categories such as type of mineral, quality parameters, and original source location. Additionally, the system dedicates fields to capture logistical aspects of the procurement process, including geographical coordinates, timestamps, and stakeholders involved.

Transactional data points are encapsulated in fields intended to record unique transaction identifiers and relevant transit details. Moreover, a Multimedia Input feature facilitates supplementary data in the form of digital photographs or documents, enhancing the veracity of the information.

The interface provides for additional comments, observations, or annotations, maintaining the system's adaptability to a range of sourcing intricacies. Beyond the direct data input, the software is equipped with an embedded validation system, primed to ensure data consistency by actively cross-referencing entered information.

To further fortify the trustworthiness of the data provided, a User Declaration 402 prompts users to affirmatively verify the veracity of the data entered. This declaration comprises a statement emphasizing the accuracy and integrity of the provided details and underscoring that the information will be subjected to validation by other platform users. A checkbox or similar selection mechanism allows users to actively acknowledge and accept this responsibility.

Upon activation of the Submit Button 403, the accumulated data is routed through the platform's consensus algorithm 310, ensuring its validation and synchronization with the broader blockchain network. This interface is designed to be user-friendly and comprehensive, allowing for flexibility and ensuring that all relevant data points are accurately captured and verified.

By accommodating a variety of data types and providing robust validation mechanisms, the Source Interface 400 ensures that the initial data entry into the blockchain network is accurate, comprehensive, and trustworthy.

FIG. 5 depicts an Auditor Interface 500 tailored for the mineral authentication agency, devised to capture critical data about the mineral's authenticity and relevant certifications.

The interface 500 is designed for documenting core verifications of the mineral's authenticity. The Data Input Fields 501 encompass categories such as mineral type confirmation, quality verifications, and cross-references with claimed source data. These fields are intended to assert the mineral's genuineness and match it with its documented origins.

The interface 500 includes fields specifically oriented towards capturing the details of the certification process. These fields may include elements like certification agency details, certification issuance timestamps, and unique certification identifiers, ensuring the traceability of every certificate.

For enhanced verification, the interface includes a Multimedia Input feature to accommodate imagery, digital documents, or any relevant media that might further validate the mineral's authenticity or highlight specific observations made during the authentication process.

To bolster the system's adaptability, a segment is dedicated to notes and annotations. This provides flexibility for the authentication agency to annotate observations, discrepancies, or any pertinent remarks about the mineral in question.

A User Declaration 502 prompts the authentication personnel to assertively verify the genuineness of the provided data. This section includes a declaration that emphasizes the responsibility of ensuring the accuracy and integrity of the entered details. It also signifies that the recorded data might undergo further scrutiny by other platform participants. Alongside this declaration, a mechanism, such as a checkbox, empowers users to consciously confirm their acknowledgment of the veracity of the information and the potential downstream validation it may undergo.

Finally, a prominently displayed Submit Button 503 is strategically positioned. Upon engagement, the compiled data undergoes preliminary verification by the consensus algorithm 310. This ensures that the authenticated data is appropriately validated before being seamlessly integrated into the overarching blockchain network.

By providing comprehensive fields for data entry, robust validation mechanisms, and flexible annotation capabilities, the Auditor Interface 500 ensures that the authentication process is thorough, accurate, and transparent, maintaining the integrity of the blockchain-based mineral supply chain tracking system.

FIG. 6 depicts an Exporter Interface 600 crafted for mineral exporters, offering a structured portal for logging critical transactional details associated with mineral export activities. This interface is designed to facilitate ease of data input while ensuring the assimilation of essential details that enhance the traceability and verification of mineral transactions.

At its core, the Data Input Fields 601 capture pivotal transactional attributes. These fields are calibrated to gather information such as export registration numbers, intended destinations, mineral quantities, shipment dates, and associated transportation methods. These inputs are crucial touchpoints in delineating the journey of minerals as they transition from their source locations to international buyers.

A User Declaration 602 prompts the exporting entity to assert the authenticity and completeness of the furnished data. This declaration underscores the accountability of the exporter in vouching for the precision of the shared information. It further indicates that the data may be subjected to cross-examination by other vested entities within the platform. Complementing this declaration, a deliberate instrument, such as a checkbox, allows the exporter to formally acknowledge their concurrence with the data's truthfulness and the subsequent verification it will undergo.

At the end of this interface 600 is a Submit Button 603. Once engaged, this button activates a series of algorithmic checks to ensure the consistency and validity of the provided details. After this initial validation, the data is queued for submission to the consensus algorithm 310, setting the stage for its eventual integration into the blockchain, contingent upon mutual consensus.

By providing structured data input fields, a user declaration, and a robust validation process, the Exporter Interface 600 ensures that all critical export-related details are accurately captured and verified, maintaining the integrity and transparency of the blockchain-based mineral supply chain tracking system.

FIG. 7 depicts an Importer Interface 700 for mineral importers, providing an organized framework for inputting pivotal transactional details related to mineral import activities. This digital portal is designed to enhance operational efficiency while consolidating indispensable data elements that fortify the traceability and verification of imported mineral consignments.

The Data Input Fields 701 are optimally configured to gather information such as import licenses, origin points, mineral categories, quantities received, and expected delivery intervals. These inputs are crucial in mapping the trajectory of minerals as they move from international frontiers to domestic reception points.

An integral facet of this interface is the User Declaration 702, where the importing entity is prompted to confirm the veracity and comprehensiveness of the recorded data. This segment serves as an affirmation, emphasizing the importer's responsibility in attesting to the accuracy of the data provided. It conveys that the information will undergo rigorous scrutiny by other stakeholders integrated into the system. An affirmation mechanism, such as a checkbox, permits the importer to formally signal their agreement to the fidelity of the data and the impending validation it will undergo.

Concluding this interface is a Submit Button 703, which initiates a series of computational verifications to ensure the coherence and legitimacy of the supplied data. Following this preliminary assessment, the data is prepared for submission to the consensus algorithm 310, setting the stage for its eventual inclusion into the blockchain, contingent upon collaborative agreement.

By providing structured data input fields, a user declaration, and a robust validation process, the Importer Interface 700 ensures that all critical import-related details are accurately captured and verified, maintaining the integrity and transparency of the blockchain-based mineral supply chain tracking system.

FIG. 8 depicts a Buyer Interface 800 designed for mineral manufacturers, such as refiners, electronic manufacturers, or jewelers, etc., serving as the final step of organized data assimilation. This interface 800 provides mineral manufacturers with an avenue to input transactional data intrinsic to their domain, thereby bolstering the fidelity and clarity of the manufacturing phase within the overarching mineral supply chain.

The Data Input Fields 801 are tailored to gather transactional information from the manufacturer's perspective. These fields may encompass details such as mineral processing techniques, final product categories, production volumes, product specifications, and associated timelines. The nature of these inputs plays an important role in chronicling the transformative journey minerals undergo from their raw state to a refined, market-ready product.

The interface 800 includes a dedicated User Declaration 802, capturing the manufacturer's obligation towards data veracity. A verification mechanism, such as a checkbox, allows the manufacturing entity to signify their affirmation of the authenticity of all cataloged details. This acknowledgment not only affirms the manufacturer's endorsement of the correctness of the recorded details but also indicates that these details will undergo rigorous validation by other participants in the ecosystem.

Finally, engaging a Submit Button 803 initiates a series of backend validations, verifying the data's integrity and relevance. After this verification, the data is relayed to the consensus algorithm 310, marking it for potential integration into the blockchain, contingent on collective approval.

By providing structured data input fields, a user declaration, and a robust validation process, the Buyer Interface 800 ensures that all critical manufacturing-related details are accurately captured and verified. This maintains the integrity and transparency of the blockchain-based mineral supply chain tracking system, ensuring that the final product's journey is meticulously documented and authenticated.

FIG. 9 depicts a Public Interface 900 tailored for mineral end-buyers and other relevant stakeholders, providing them with a limited but informative view into the mineral supply chain. Specifically designed to provide transparency without compromising the sanctity of sensitive data, this interface balances public scrutiny and consortium discretion.

The Transaction Details 901 window displays an array of pre-verified and consortium-sanctioned data points related to the mineral's journey. This ensures that while end-buyers gain insights into the mineral's origin, other sensitive transactional data remains shielded from public disclosure. The spectrum of information presented is comprehensive yet selective. Users can view details pertaining to the mineral's origin, transportation phases, and processing milestones, while being prevented from accessing any data deemed sensitive or proprietary by the consortium members. The data's read-only nature reiterates the consortium's commitment to uphold transparency with end-buyers without jeopardizing the integrity or confidentiality of certain operational intricacies.

By providing a curated and secure view of the supply chain, the Public Interface 900 ensures that end-buyers and stakeholders are well-informed about the mineral's provenance and journey, fostering trust and transparency within the blockchain-based mineral supply chain tracking system.

FIG. 10 depicts the Administrator Interface 1000 software window associated with the responsibilities of the consortium owner within the blockchain system. This interface is tailored to ensure the system's overall integrity and operability, designed for data inspection and blockchain inclusion.

The interface presents Transaction Metadata 1001 extracted directly from the consortium blockchain. Key sections of the interface 1000 facilitate the display of crucial blockchain information such as transaction ID, timestamp, registered username, amount transferred, and location details.

Integral to this window are a Validate Button 1002 and a Reject Button 1003, which are mechanisms to validate or reject input data against the established consensus rules of the consortium blockchain. Additionally, diagnostic utilities, including error logs and system health indicators, assist in the proactive identification of potential issues. A dedicated section is also present for interfacing with associated smart contracts, if the blockchain supports such features.

By providing comprehensive tools for data validation, diagnostic utilities, and smart contract management, the Administrator Interface 1000 ensures that the consortium owner can maintain the blockchain system's integrity and operability. This interface is crucial for overseeing the proper inclusion of transaction data and addressing any issues that may arise within the blockchain network.

FIG. 11 portrays an embodiment of the Automatic Approval Module, an alternate approval mechanism to the Administrator Interface, designed to streamline the blockchain submission process. The module is integrated within the broader system to enhance the efficiency and speed of data verification and approval, ensuring the rapid addition of relevant and accurate entries to the blockchain.

Incoming Data 1100 serves as the initial data set that feeds into the approval system. This data typically comprises transaction records, cryptographic signatures, or other relevant blockchain data elements. The Data Feed 1101 is a secure pathway through which this data is transmitted to the respective computational units for further analysis. Network Security 1107 protocols are in place to ensure that the transmission of data between these modules is encrypted and secure against unauthorized access or tampering.

Central to this module is the Algorithmic Approval Engine 1102. This engine utilizes predefined rules and criteria set by the consortium or governing body of the blockchain network. It examines Incoming Data against these established benchmarks, determining its validity and reliability. Notable criteria may encompass data completeness, adherence to industry standards, and consistency with previously validated data sets.

For entries that demand greater accuracy or involve nuanced patterns, the Artificial Intelligence (A.I.) Analytical Engine 1104 is invoked. This A.I. component, trained on vast historical transaction datasets, recognizes complex patterns and anomalies. It assists in discerning the validity of intricate or non-standard transaction data, providing an additional layer of scrutiny.

The Decision Interface 1103 is responsible for the final approval or rejection of data. Transaction data entered into the Algorithmic Approval Engine is transferred through an Algorithmic Network 1105, and data entered into the A.I. Analytical Engine is transferred through an A.I. Network 1106. The data is then set for Approval 1108. Transactions that raise flags or inconsistencies are Canceled 1109. Those that meet the approval criteria are immediately added to the Blockchain Network 1110.

A feature that differentiates this module is the Feedback Loop 1111 mechanism. Every approval or rejection feeds back into the A.I. Analytical Engine, refining its decision-making capabilities over time. This continuous learning process ensures that the module's efficiency and accuracy improve with every transaction, adapting to evolving data patterns and industry standards.

While the above detailed description has shown, described, and pointed out novel features as applied to various embodiments, it can be understood that various omissions, substitutions, and changes in the form and details of the devices or algorithms illustrated can be made without departing from the spirit of the disclosure. As can be recognized, certain embodiments described herein can be embodied in a form that does not provide all of the features and benefits set forth herein, as some features can be used or practiced separately from others. The scope of certain embodiments disclosed herein is indicated by the appended claims rather than by the foregoing description. All changes that come within the meaning and range of equivalency of the claims are to be embraced within their scope.

1. A system for tracking and verifying the authenticity of precious metals, base metals, and other minerals throughout a supply chain, comprising a consortium blockchain platform configured to securely store transaction data related to the production, transportation, and sale of said metals and minerals, and means for recording data in an immutable and transparent manner.

2. The system of claim 1, further comprising various interfaces for mineral sourcing entities, authentication agencies, exporters, importers, manufacturers, and end-buyers to input, verify, and view transaction data.

3. The system of claim 2, wherein said interfaces are comprised of data fields tailored to capture specifics relevant to each entity's role within the supply chain, a user declaration section for affirming the accuracy of the input data, and a submission mechanism to initiate data verification processes.

4. The system of claim 1, wherein the consortium blockchain comprises and utilizes a consensus algorithm 310, enabling verification of input data by multiple members prior to appending to the blockchain.

5. The system of claim 1, further comprising a method to record and validate every phase of the mineral's journey, ensuring ethically and sustainably sourced and produced minerals.

6. The system of claim 1, wherein the blockchain network comprises centralized and decentralized servers facilitating data flow and communication within the network.

7. The system of claim 1, further comprising cryptographic links connecting individual nodes of the blockchain, ensuring security and data integrity.

8. The system of claim 2, further comprising a public interface offering end-buyers and stakeholders a limited view of select, non-confidential transaction data.

9. The system of claim 8, wherein the public interface provides access to said transaction details via a block explorer functionality, revealing transaction metadata without exposing sensitive information.

10. The system of claim 1, wherein each transaction data point is associated with a unique QR code, enabling end-users to access specific transaction details.

11. The system of claim 2, comprising a method for securing data input and retrieval, ensures that data is both accurate at the source and remains unaltered through the system's processes.

12. The system of claim 1, designed for application and use by producers, traders, dealers, manufacturers, regulatory bodies, auditors, end-buyers, and other third-party verifiers within the mineral industry.

13. The system of claim 2, wherein the interfaces are modular and adaptable, allowing for seamless integration with existing supply chain operations.

14. The system of claim 1, wherein the blockchain platform is further comprised of smart contract capabilities, automating certain processes and verifications within the system.

15. A software window tailored for blockchain administrators, comprising tools to validate, test, and append new data entries to the blockchain, and functionalities to monitor the health and status of the blockchain infrastructure.

16. The system of claim 15, further comprising an automatic approval module integrated to enhance the efficiency and speed of data verification and approval, ensures rapid addition of relevant and accurate entries to the blockchain.

17. The system of claim 16, wherein the automatic approval module includes an algorithmic approval engine utilizing predefined rules and criteria for data validation, an artificial intelligence analytical engine trained on historical transaction datasets for recognizing complex patterns and anomalies, and a feedback loop mechanism that refines the decision-making capabilities of the A.I. engine over time.
